(19) United States
(12) Patent Application Publication
(10) Pub. No.: US 2014/0071532 A1
(43) Pub. Date: Mar. 13, 2014

(54) COLOR FILTER

(71) Applicants: Yan Ye, Jiangsu (CN); Linsen Chen, Jiangsu (CN)

(72) Inventors: Yan Ye, Jiangsu (CN); Linsen Chen, Jiangsu (CN)

(73) Assignees: Suzhou University, Jiang (CN); SVG Optronics ,Co., Ltd., Jiangsu (CN)

(21) Appl. No.: 13/994,067

(22) PCT Filed: Dec. 16, 2010
(86) PCT No.: PCT/CN2010/079905

§ 371 Date: Nov. 25, 2013

(51) Int. Cl. G02B 5/20

(52) U.S. Cl. CPC G02B 5/203
USPC 359/568

(57) ABSTRACT

The present invention discloses a color filter includes a substrate layer and a medium grating layer, wherein the medium grating layer, arranged on the substrate layer, has a grating structure of periodic arrangement. The color filter is characterized in that: the medium grating layer is provided with a metal profiling film, which covers the ridge portion of the grating structure, one or two sides of the lateral portion of the grating structure, and a part of the groove portion of the grating structure, with the area of the groove portion of the grating structure covered by the metal profiling film occupying 30%-95% of the total area of the lateral portion and the groove portion. By providing the metal profiling film, this invention can break the condition of the original metal surface plasmon resonance, and reduce influence of the incident angle of light on the resonance condition, thus achieving the filtering effect within a relatively wide range of angle.

### FIELD OF THE INVENTION

The present invention relates to an optical element used for filtering light, particularly to a grating-type color filter.

### BACKGROUND OF THE INVENTION

A conventional color filter (CF) is produced by preparing organic materials of three colors of R, G and B onto a transparent substrate by such methods as photolithography, printing, and deposition. The color filter of this type needs the three different organic materials to be formed successively on the substrate in the production, thus having such defects as uneven thickness and poor color purity; besides, because of complexity of the process steps, the production cost is extremely high, making the color filter particularly disadvantageous in its application to the large-sized panels. To overcome the above defects, some novel color filters have been proposed.

The color filter produced with the grating structure, because of its high light utilization efficiency and mature production process, has become the development direction of the color filter of the next generation. The currently known grating-type color filter includes a single layer metal grating structure, a multilayer medium grating structure, and a cascade grating structure of the medium grating and the metal grating. Wherein the color filter of the cascade grating structure both overcomes the low transmission efficiency of the medium grating, and reduces crosstalk of the metal grating, thus becoming a popular research direction of the grating-type color filter.

FIG. 1 shows an existing color filter of the cascade grating. As shown in the drawing, in this color filter 100, a medium grating layer 120 and a metal grating layer 130 are arranged on the substrate 110, wherein the metal grating layer 130 covers the ridge portion 121 and the groove portion 122 of this medium grating layer 120. When the frequency of an incident light forms guided-mode resonance with the cascade grating, this incident light can then be transmitted, while the light of other frequencies is reflected, thus achieving the filtering effect.

However, in this color filter of the grating structure, because the guided-mode resonance condition is strongly dependent on the incident angle of the incident light, i.e. the guided-mode resonance condition changes with the incident angle of the incident light, the transmission spectrum will move toward both sides to even disappear, which greatly limits application of the color filter in the actual production.

### BRIEF DESCRIPTION OF THE INVENTION

A purpose of the present invention is to provide a color filter of a cascade grating structure, and reduce the influence of the incident angle of light on the resonance conditions by improving its structure, so as to achieve the filtering effect within a relatively wide range of angle.

In order to achieve above purpose, the present invention adopts the following technical solution:

A color filter, comprising a substrate layer and a medium grating layer, wherein the medium grating layer, arranged on the substrate layer, has a grating structure of periodic arrangement and is provided with a metal profiling film, which covers the ridge portion of the grating structure, one or two sides of the lateral portion of the grating structure, and a part of the groove portion of the grating structure, with the area of the groove portion of the grating structure covered by the metal profiling film occupying 30%-95% of the total area of the lateral portion and the groove portion.

A further technical solution further includes a medium profiling film, which is arranged between the grating structure and the metal profiling film of the medium grating layer.

In the above technical solution, at least one of the media in the medium grating layer and the medium profiling film has a refractive index greater than 1.65, which is then a high refractive index medium.

The medium grating layer meets the guided-mode resonance condition, or the combination of the medium grating layer and the medium profiling film meets the guided-mode resonance condition.

In the above technical solution, the medium profiling film is arranged at the ridge portion, the single side and the groove portion of the grating structure, or at the ridge portion and the single side of the grating structure, or at the ridge portion and the groove portion of the grating structure, or at the ridge portion, the bilateral portion and the partial groove portion of the grating structure.

A further technical solution further includes a medium cover layer, which is arranged on the metal profiling film and covers and fills up the grating structure. In a preferred technical solution, an interval is left between the metal profiling film on the partial groove portion and at least one of the lateral portions on both sides of the groove. In the above technical solution, the metal profiling film is arranged at the ridge portion, the single lateral portion and the partial groove portion of the grating structure, wherein the metal profiling film on the partial groove portion is connected with that on the single lateral portion, and an interval is left between the metal profiling film on the partial groove portion and the other single lateral portion opposite the single lateral portion provided with the metal profiling film.

In the above technical solution, the period of the grating structure is less than the wavelength of the incident light.

With the above technical solutions, the present invention has the following advantages compared with the prior art:

The present invention provides a grating-type color filter, which has a cascade structure composed of a medium grating with the addition of a metal profiling film; meanwhile, a notch is provided in the metal layer covering the groove portion of the grating, making a part of the medium grating layer exposed, thus lowering the angle sensitivity of the resonant output, reducing influence of the incident angle of light on the resonance condition, thereby achieving the filtering effect within a relatively wide range of angle.

### BRIEF DESCRIPTION OF THE DRAWINGS

FIG. 1 shows an existing color filter of the cascade grating;

FIG. 2 is a structural schematic diagram of the color filter of the present invention;

FIG. 3 is a structural schematic diagram of the first embodiment of the color filter of the present invention;

FIGS. 4A-4C are transmittance change diagrams of a light wave of the three colors in the example at different angles;

FIG. 5 is a structural schematic diagram of the second embodiment of the color filter of the present invention;

FIGS. 6A-6C are transmittance change diagrams of a light wave of the three colors in the example at different angles;

FIG. 7 is a structural schematic diagram of the color filter of the present invention that is applied to a liquid crystal display;

FIGS. 8-10 are schematic diagrams of the transmission spectrum changing with the incident angle in the case of different coverage rate of the metal profiling film in Example 3; and

FIG. 11 is a schematic diagram of the transmission spectrum changing with the thickness of the metal profiling film in Example 3.

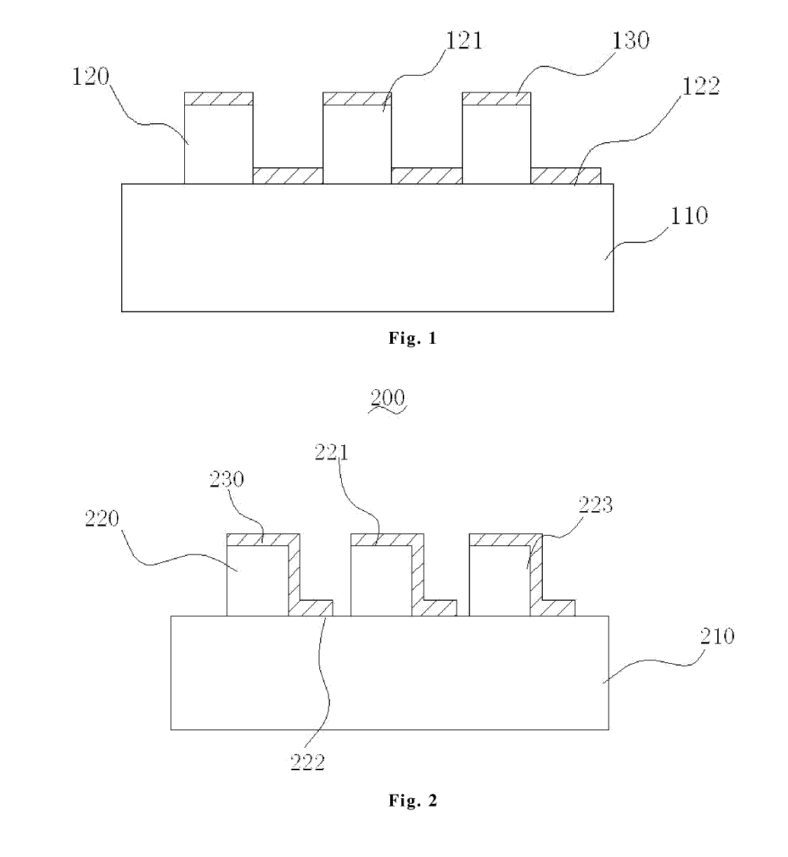

### DETAILED DESCRIPTION OF THE INVENTION

The present invention will further be described below with reference to drawings and examples:

FIG. 2 is a structural schematic diagram of the color filter of the present invention. As shown in the drawing, the color filter 200 includes a substrate 210, a medium grating layer 220 and a metal profiling film 230. Wherein the medium grating layer 220 has a grating structure of periodic arrangement, including a ridge portion 221, a groove portion 222 and a lateral portion 223. The metal profiling film 230 is arranged on the ridge portion 221, the lateral portion 223 and the partial groove portion 222 of the grating structure. The present invention, with this special micro-structural design, makes the metal profiling film expose a part of this medium grating on the groove portion 222, thus lowering the angle sensitivity of the resonance, reducing the influence of the incident angle of light on the resonance condition compared with the existing cascade grating, thereby achieving the filtering effect within a relatively wide range of angle. The structure of the color filter of the present invention will be described below in detail with reference to the embodiments.

### Example 1

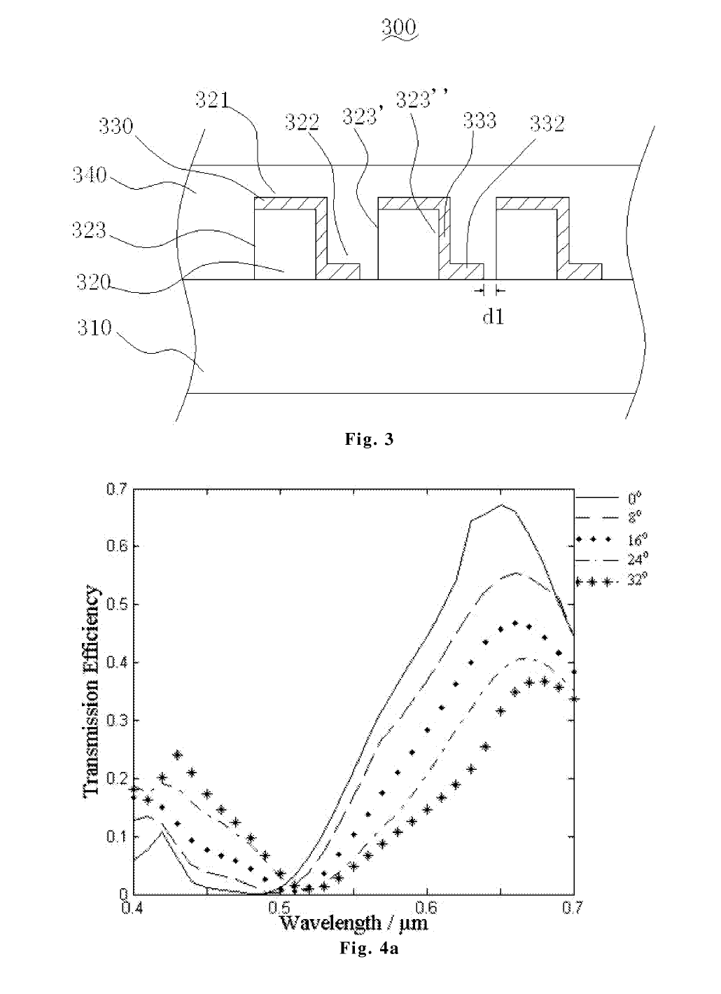

FIG. 3 is a structural schematic diagram of the first embodiment of the color filter of the present invention. As shown in the drawing, in this color filter 300, the metal profiling film 330 is arranged on the ridge portion 321, the single lateral portion 323′ and the partial groove portion 322 of the medium grating layer 320, wherein the metal profiling film 332 on the partial groove portion 322 is connected with the metal profiling film 333 on the single lateral portion 323′, and an interval dl is left between the metal profiling film 332 on the partial groove portion 322 and the other single lateral portion 323″ opposite the single lateral portion 323′ provided with the metal profiling film. The metal profiling film 330 of this structure can be formed at a time on the medium grating 320 by oblique sputtering. The method of mask lithography can also be used, wherein the medium grating 320 is first plated with a layer of metal, and then the interval dl is formed by etching with the photoresist.

In an application, the color filter 300 further includes a medium cover layer 340, which is arranged on the metal profiling film 330 and covers and fills up the grating structure of this medium grating layer 320.

The medium grating layer 320 and the substrate 310 may be of either the same or different materials. The size of the grating structure on this medium grating layer 320 is less than the wavelength of the incident light. Preferably, this medium grating layer 320 is a medium having a high refractive index, and the grating structure on the medium grating layer 320, i.e. the period and spatial frequency, meets the conditions under which the guided-mode resonance can be formed with the frequency of the incident light, thereby making the incident light have a higher transmittance. Taking the most common red light filter, green light filter and blue light filter as an example. Table 1 gives the grating structure under the filter of the three colors of light:

TABLE 1
Parameters of the grating structure of the three colors of light,
red, green and blue (unit: nm)

| | h1: 250; h2: 60; | | |
|---|---|---|---|
| | h3: 10 | | |
| | P | f | λ |
| Red | 420 | 0.38 | 670 |
| Green | 330 | 0.39 | 540 |
| Blue | 260 | 0.33 | 425 |

Wherein h1 is the thickness of the medium grating layer 320, h2 is the thickness of the metal profiling film 330, h3 is the thickness of the medium cover layer 340, P is the width of a single period of the medium grating, f is the spatial frequency of the grating structure, and A is the wavelength of the incident light.

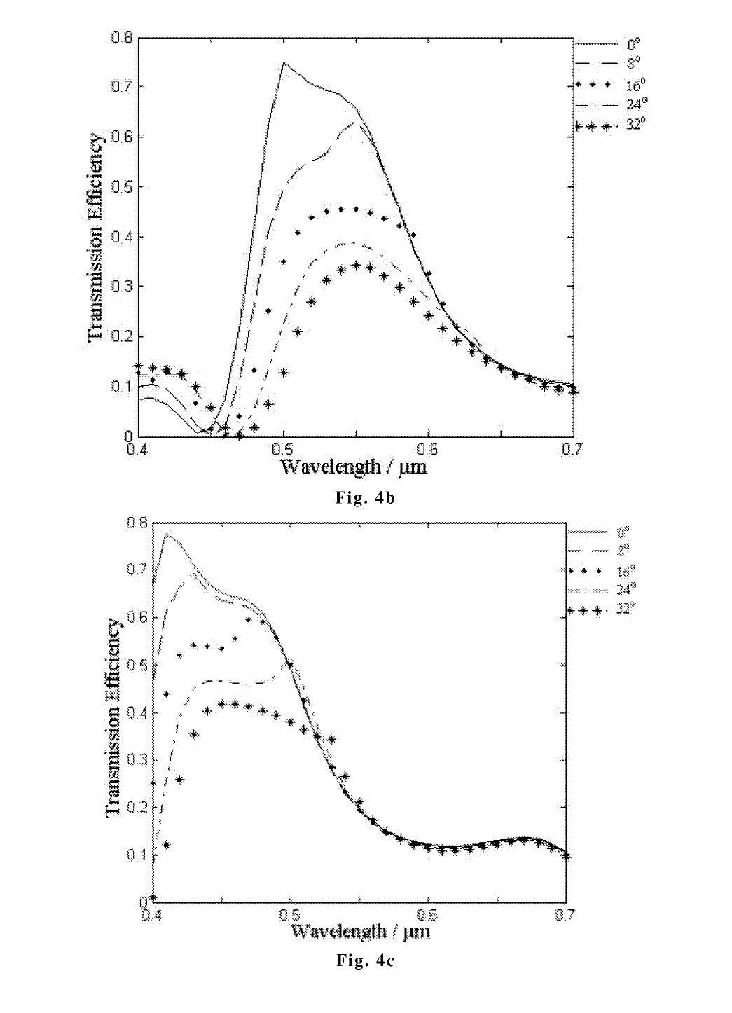

FIGS. 4A-4C are transmittance change diagrams of a light wave of the three colors in the example at different angles. As shown in the drawings, when the incident angle changes from 0 degree to 32 degrees, there is only a slight change of the light at the respective maximum transmittance of the three filters of red, green and blue light. Taking the green light filter as an example: when the incident angle is 0 degree, the wavelength of the light at the maximum transmittance is about 500 nm; when the angle reaches 32 degrees, the wavelength of the light at the maximum transmittance is about 540 nm, still in the green light waveband. These indicate that the filter in this embodiment can allow change within a wide range of angle, and achieve the filtering effect.

It should be noticed that the structure of the metal profiling film 330 in this example is only a structure conducive to the production. In actual applications, this metal profiling film 330 can also have a variety of variant structures, e.g. the metal profiling film can be formed either on both of the two single lateral portions 323 or only on any one of the lateral portions. The metal profiling film 332 on the groove portion 322 can either form an interval with both of the two lateral portions intersected with each other, or form an interval with any one of them, with only a part of the medium grating needing to be exposed, so as to lower the angle sensitivity of the resonance.

### Example 2

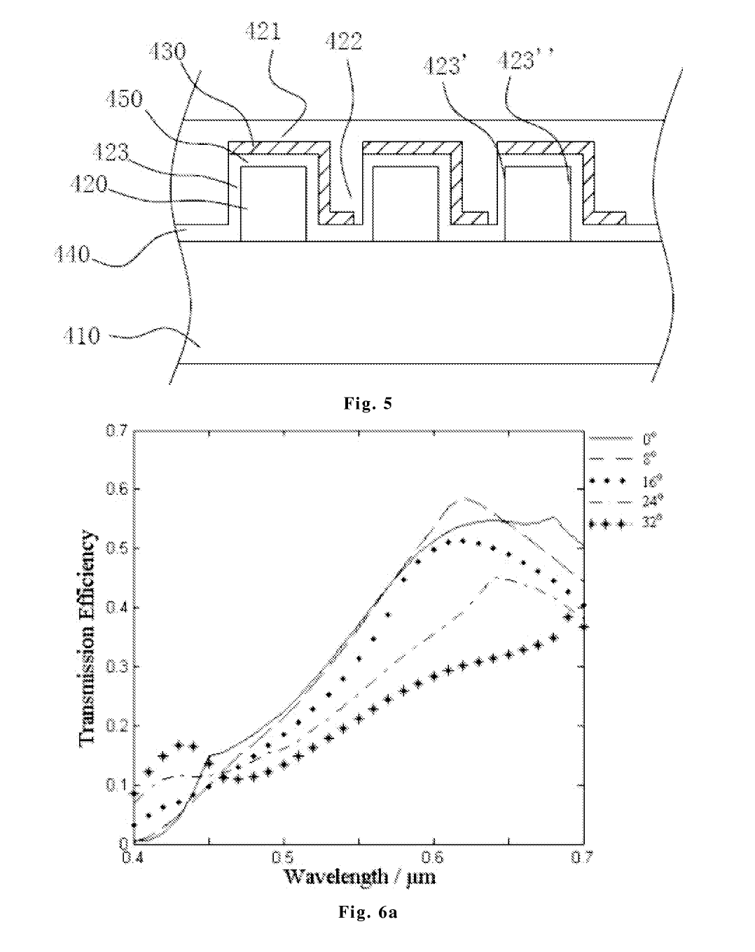

FIG. 5 is a structural schematic diagram of the second embodiment of the color filter of the present invention. As shown in the drawing, the color filter 400 includes a substrate 410, a medium grating layer 420, a metal profiling film 430, a medium cover layer 440, and a medium profiling film 450. Wherein the medium profiling film 450 is arranged between the medium grating layer 420 and the metal profiling film 430. The medium profiling film 450 is of a material having a high refractive index, and can be formed on the medium grating layer 420 by such methods as sputtering, vapor deposition or electroplating. Compared with Example 1, because of preparing the medium profiling film 450 of a material having a high refractive index on the medium grating layer 420 so as to make it have the property of guided-mode resonance, Example 2 has no requirements for the material properties of the medium grating layer 420 itself, thus allowing selection of the materials having a low refractive index that are more conductive to processing for the preparation of the medium grating layer 420, thereby lowering processing difficulty and cost of the color filter consumedly.

Furthermore, the medium profiling film 420 can be arranged at various positions, e.g. at the ridge portion 421 of the medium grating layer 420, on the single lateral portion 423′ (or 423″) and the groove portion 422, on the ridge portion 421 and the single lateral portion 423′ (or 423″), on the ridge portion 421 and the groove portion 422, or on the ridge portion 421, the bilateral portion 423 and the groove portion 422.

While for the metal profiling film 430, its structure is the same with that in Example 1, and will thus not be described here in detail.

The light-transmitting properties of the color filter in this embodiment will be given below by taking the filter of the three colors of light, red, green and blue, as an example. Table 2 gives the grating structure under the filter of the three colors of light.

TABLE 2
Parameters of the grating structure of the three colors of light,
red, green and blue (unit: nm)

| | h4: 180; h5: 60; | | |
|---|---|---|---|
| | h6: 20; h7: 20 | | |
| | P′ | f′ | λ′ |
| Red | 450 | 0.5 | 640 |
| Green | 400 | 0.5 | 540 |
| Blue | 320 | 0.5 | 425 |

Wherein h4 is the thickness of the medium grating layer 420, h5 is the thickness of the medium profiling film 450, h6 is the thickness of the metal profiling film 430, h7 is the thickness of the medium cover layer 440, P′ is the width of a single period of the medium grating, f′ is the spatial frequency of the grating structure, and λ′ is the wavelength of the incident light.

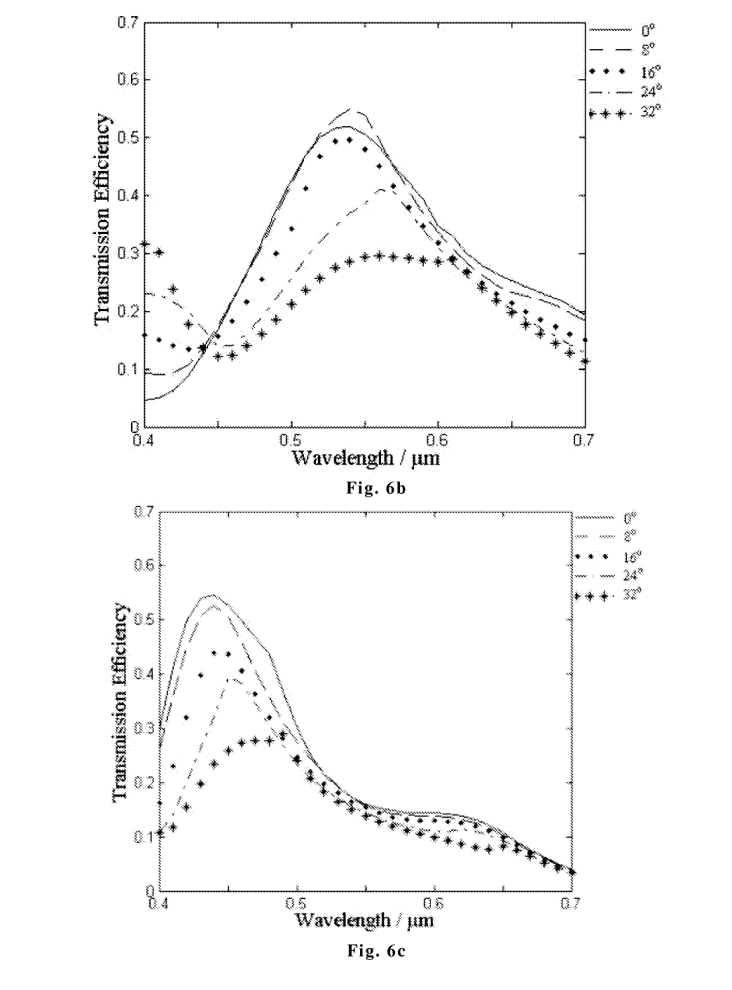

FIGS. 6A-6C are transmittance change diagrams of a light wave of the three colors in the example at different angles. As shown in the drawings, when the incident angle changes from 0 degree to 32 degrees, there is only a slight change of the light at the respective maximum transmittance of the three filters of red, green and blue light. Taking the green light filter as an example: when the incident angle is 0 degree, the wavelength of the light at the maximum transmittance is about 530 nm; when the angle reaches 32 degrees, the wavelength of the light at the maximum transmittance is about 560 nm, still in the green light waveband. These indicate that the filter in this embodiment can allow change within a wide range of angle, and achieve the filtering effect.

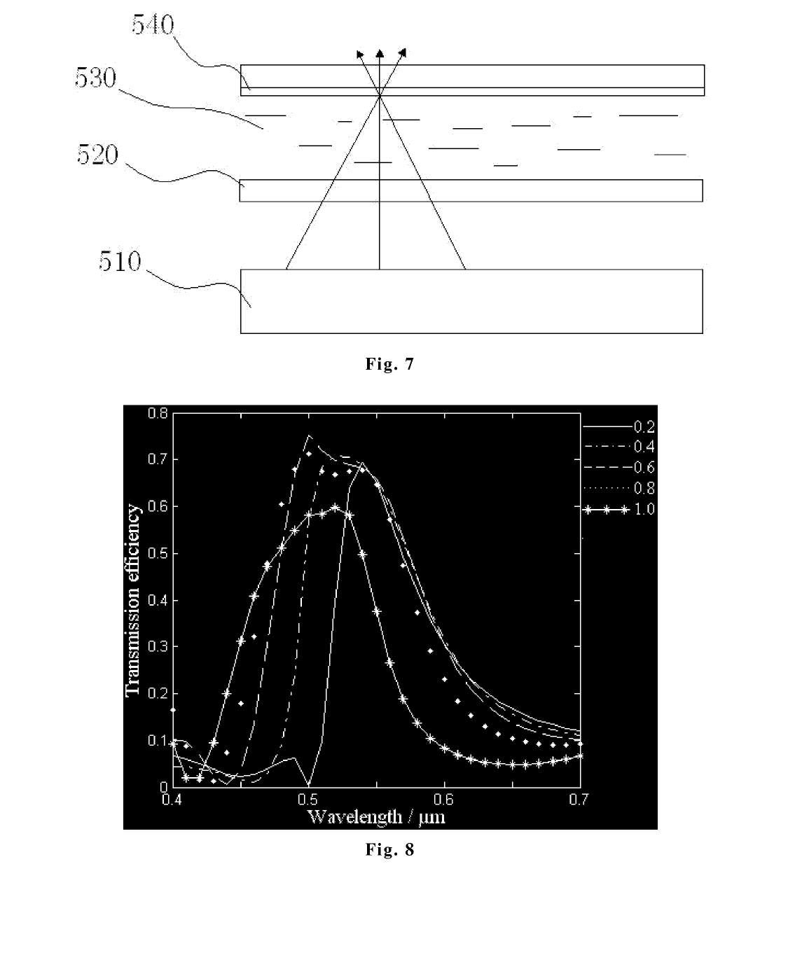

FIG. 7 is a structural schematic diagram of the color filter of the present invention that is applied to a liquid crystal display. As shown in the drawing, the light emitted by the backlight module 510 goes through a TFT substrate 520 and a liquid crystal layer 530 before going through the color filter 540 of the present invention. This color filter 540 allows accepting an incident light in a relatively wide range of angle and thus, compared with the existing grating-type color filter, can increase the light utilization, enhance brightness of the screen, and improve the display quality.

### Example 3

For the green light filter in Example 1, the width ratio f2 of the metal film 332 to the groove portion 322 is defined, i.e. f2 refers to the coverage rate of the metal profiling film; for the coverage rate f2 of the metal film 332 in the groove portion 322 increased from 0.2 to 1, the corresponding transmission spectrum is as shown in FIG. 8. The bandwidth of the transmission spectrum gradually increases with the coverage rate of the metal film, while the extreme value of transmittance changes less; when the metal film covers the groove portion completely, the extreme value of transmittance is reduced significantly.

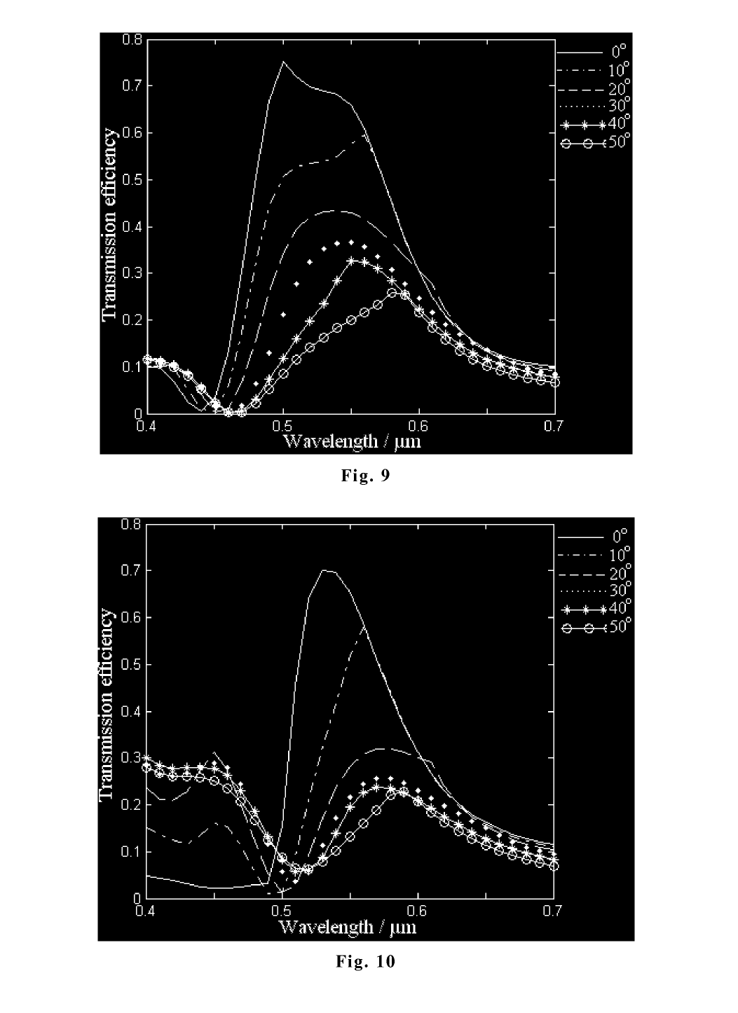

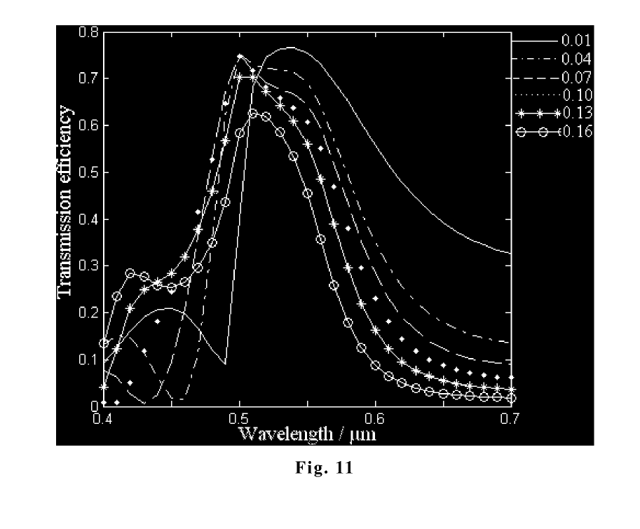

For the incident angle changing from 0 degree to 50 degrees, the transmission spectrum is as shown in FIG. 9 when f2 is 0.6; the central spectrum position of the transmission spectrum changes less with the incident angle, whereas the color output is constant. The transmission spectrum is as shown in FIG. 10 when f2 is 0.3; when the incident angle is 20 degrees, the sideband sub-peak output is close to the filtering output efficiency, and the outputted spectrum is no longer green. This shows that the allowed change of angle is relatively less when the coverage rate is less.

For the green light filter in Example 1, when the thickness h2 of the metal profiling film 330 changes in the range of 0.01-0.16 μm, the corresponding transmission spectrum is shown in FIG. 11; when the thickness is less than 0.04 μm, the sideband transmission spectrum is great; when the thickness is greater than 0.13 μm, the transmittance decreases by a big margin. The color output changes less with the thickness of the metal film.

What is claimed is:

1. A color filter, comprising a substrate layer and a medium grating layer, wherein the medium grating layer, arranged on the substrate layer, has a grating structure of periodic arrangement, characterized in that: the medium grating layer is provided with a metal profiling film, which covers the ridge portion of the grating structure, one or two sides of the lateral portion of the grating structure, and a part of a groove portion of the grating structure, with the area of the groove portion of the grating structure covered by the metal profiling film occupying 30%-95% of the total area of the lateral portion and the groove portion.

2. The color filter according to claim 1, wherein a medium profiling film is further included, said medium profiling film is arranged between the grating structure of the medium grating layer and the metal profiling film.

3. The color filter according to claim 2, wherein at least one of the media in said medium grating layer and said medium profiling film has a refractive index greater than 1.65.

4. The color filter according to claim 2, wherein said medium profiling film is arranged at the ridge portion, the single side and the groove portion of said grating structure, or at the ridge portion and the single side of said grating structure, or at the ridge portion and the groove portion of said grating structure, or at the ridge portion, the bilateral portion and the partial groove portion of said grating structure.

5. The color filter according to claim 1, wherein a medium cover layer is further included, said medium cover layer is arranged on said metal profiling film and covers and fills up the grating structure.

6. The color filter according to claim 1, wherein an interval is left between the metal profiling film on the partial groove portion and at least one of the lateral portions on both sides of the groove.

7. The color filter according to claim 6, wherein said metal profiling film is arranged at the ridge portion, the single lateral portion and the partial groove portion of the grating structure, wherein the metal profiling film on the partial groove portion is connected with that on the single lateral portion, and an interval is left between the metal profiling film on the partial groove portion and the other single lateral portion opposite the single lateral portion provided with the metal profiling film.

8. The color filter according to claim 1, wherein the period of the grating structure is less than wavelength of an incident light.
